(19) United States
(12) Patent Application Publication
(10) Pub. No.: US 2016/0000527 A1
(43) Pub. Date: Jan. 7, 2016

(54) APPARATUS FOR ORTHODONTIC ALIGNER TRAY RETENTION

(71) Applicant: Airton Arruda, Ann Arbor, MI (US)

(72) Inventor: Airton Arruda, Ann Arbor, MI (US)

(21) Appl. No.: 14/855,685

(22) Filed: Sep. 16, 2015

Related U.S. Application Data
(63) Continuation of application No. 13/866,193, filed on Apr. 19, 2013, now abandoned.
Application No. 13/866,193 is a continuation-in-part of application No. 13/327,469, filed on Dec. 15, 2011, now abandoned.
(60) Provisional application No. 61/813,614, filed on Apr. 18, 2013.

(51) Int. Cl. A61C 7/08

(52) U.S. Cl. CPC A61C 7/08

(57) ABSTRACT

An apparatus is disclosed to retain an orthodontic aligner tray to teeth of the patient includes the aligner tray, a retention feature securing the aligner tray to the teeth of the patient, and an adhering agent connecting the aligner tray and the retention feature. The retention feature includes a C-shaped clip securing the aligner tray to the teeth of the patient, wherein C-shaped clip includes a single contiguous retention feature aligned to a space between two adjacent teeth and spanning from a first terminal end of the C-shaped clip at a lingual gingival margin to a second terminal end of the C-shaped clip at a labial gingival margin and at least one elongated feature in one of the lingual gingival margin and the labial gingival margin extending perpendicularly from a body of the C-shaped clip along a gum line to increase gripping force upon the teeth.

### CROSS REFERENCE TO RELATED APPLICATIONS

This disclosure is a continuation of U.S. application Ser. No. 13/866,193 filed on Apr. 19, 2013 which claims the benefit of U.S. Provisional Application No. 61/813,614 filed on Apr. 18, 2013 and is a continuation in part of U.S. application Ser. No. 13/327,469 filed on Dec. 15, 2011, which are hereby incorporated by reference.

### TECHNICAL FIELD

This disclosure is related to removable orthodontic appliances including improved structure for retention to a patient's teeth.

### BACKGROUND

The statements in this section merely provide background information related to the present disclosure. Accordingly, such statements are not intended to constitute an admission of prior art.

An aligner tray is a dental device used by an orthodontic professional to adjust the alignment and/or positions of a patient's teeth. According to one exemplary embodiment, an aligner tray is a formed polymer with tooth shaped cavities which fits over all or most of either the upper or lower teeth of the patient. A pair of aligner trays can be used, one fitted to the upper teeth and a second fitted to the lower teeth. According to one exemplary embodiment, the aligner tray is made of a substantially transparent plastic approximately one to three millimeters thick.

An aligner tray is based upon the pre-existing alignment and position of the teeth of the patient. The tooth shaped cavities in the aligner tray include small alignment and/or position changes as compared to the pre-existing alignment and position of the teeth of the patient. According to one exemplary embodiment, a series of aligner trays can be used sequentially, each tray implementing incremental changes to tooth alignment and/or position.

A dental impression is a tool utilized by orthodontic professionals to model a patient's teeth. A dental impression can be made by fitting a first soft substance to the teeth of the patient, and then making a hardened dental impression of the teeth by using the first soft substance as a mold. In one exemplary embodiment, the dental impression can be made of plaster. An aligner tray can be made by pressure-forming a flat plastic blank over the dental impression. Pressure-forming, including using a positive pressure or a pressure greater than atmospheric pressure to press down upon a blank or using a vacuum or pressure less than atmospheric pressure to pull down upon a blank, is a technique known in the art and will not be discussed in detail herein. Pressure-forming will be used to disclose a manufacturing method herein, and it will be assumed throughout that either a positive pressure method or a vacuum method can be utilized. Pressure-forming the flat plastic blank over the dental impression results in an aligner tray being formed that fits perfectly to the dental impression. By modifying the dental impression, adjusting the teeth of the dental impression, the resulting aligner tray can include changes in alignment and/or position as compared to the teeth of the patient. According to one exemplary embodiment, a plurality of dental impressions can be formed based upon the teeth of the patient, and the orthodontic professional can remove from the dental impression the teeth that need to be adjusted. By using clay, wax, plaster, or a similar substance to relocate the removed teeth to the remainder of the impression, the orthodontic professional can model the desired changes to the patient's teeth and use the impression to create an aligner tray to create the desired effect.

Traditional orthodontic braces include wires running through appliances semi-permanently adhered to the surface of the teeth. Aligner trays have a beneficial feature as compared to traditional braces in that the aligner trays can be removed occasionally, for example, to permit the patient to eat without the aligner trays being present in the patient's mouth. However, the aligner trays must be retained properly to the teeth in order to correctly realign and/or reposition the teeth.

### SUMMARY

An apparatus is disclosed to retain an orthodontic aligner tray to teeth of the patient includes the aligner tray, a retention feature securing the aligner tray to the teeth of the patient, and an adhering agent connecting the aligner tray and the retention feature. The retention feature includes a C-shaped clip securing the aligner tray to the teeth of the patient, wherein C-shaped clip includes a single contiguous retention feature aligned to a space between two adjacent teeth and spanning from a first terminal end of the C-shaped clip at a lingual gingival margin to a second terminal end of the C-shaped clip at a labial gingival margin and at least one elongated feature in one of the lingual gingival margin and the labial gingival margin extending perpendicularly from a body of the C-shaped clip along a gum line to increase gripping force upon the teeth.

### BRIEF DESCRIPTION OF THE DRAWINGS

One or more embodiments will now be described, by way of example, with reference to the accompanying drawings, in which:

FIG. 1 illustrates an exemplary aligner tray including retention features, in accordance with the present disclosure;

FIG. 2 illustrates an exemplary aligner tray including retention features located to the teeth of a patient, in accordance with the present disclosure;

FIG. 3 illustrates an exemplary aligner tray, retention features, and an adhering agent locating the retention features to the aligner tray, in accordance with the present disclosure;

FIG. 4 illustrates in cross section an exemplary aligner tray, a C-shaped clip, and an adhering agent, in accordance with the present disclosure;

FIG. 5 illustrates an exemplary square retention clip, in accordance with the present disclosure;

FIG. 6 illustrates an exemplary retention clip with an extended closed end, in accordance with the present disclosure;

FIG. 7 illustrates an exemplary retention bracket aligned to a plurality spaces between teeth of a patient, in accordance with the present disclosure;

FIG. 8 illustrates an exemplary retention clip made of a polymer, in accordance with the present disclosure;

FIG. 9 illustrates exemplary retention features located to a dental impression including an adhering agent applied to the dental impression proximate to the retention features in preparation for a pressure-forming process, in accordance with the present disclosure;

FIG. 10 illustrates an aligner tray corresponding to an upper jaw of a patient, an aligner tray corresponding to a lower jaw of a patient, and elastic band retention features located to each of the aligner trays, in accordance with the present disclosure;

FIG. 11 illustrates an aligner tray including a retention bracket spanning both sides of the aligner tray, in accordance with the present disclosure;

FIG. 12 illustrates an aligner tray including a retention bracket spanning both sides of the aligner tray including central portion of the bracket with a wide arc configuration, in accordance with the present disclosure; and

FIG. 13 illustrates a piston device pushing upon the lower jaw in a forward direction, in accordance with the present disclosure.

FIG. 14A and FIG. 14B illustrate an exemplary arcuate retention clip, with affixing features embodied as raised protrusions, in accordance with the present disclosure;

FIG. 15A and FIG. 15B illustrate an exemplary arcuate retention clip, with affixing features embodied as depressed indentations, in accordance with the present disclosure;

FIG. 16A and FIG. 16B illustrate an exemplary arcuate retention clip, with affixing features embodied as projecting tabs, in accordance with the present disclosure;

FIG. 17A and FIG. 17B illustrate an exemplary arcuate retention clip, with affixing features embodied as mushroom-shaped tabs, in accordance with the present disclosure;

FIG. 18A and FIG. 18B illustrate an exemplary arcuate retention clip, the surface recessed with grooves and ridges or creases formed by a plurality of wrapped wires, in accordance with the present disclosure;

FIG. 19 illustrates in side view an exemplary retention clip that can be used to grip to the teeth of a patient, wherein the clip includes an irregular cross section, in accordance with the present disclosure;

FIG. 20 illustrates another exemplary embodiment of a retention clip with an irregular cross section, in accordance with the present disclosure;

FIG. 21 illustrates another exemplary embodiment of a retention clip with an irregular cross section, in accordance with the present disclosure;

FIG. 22 illustrates the retention clip of FIG. 21 installed to the teeth of a patient, in accordance with the present disclosure;

FIG. 23 illustrates a polymer retention clip formed around a wire, wherein the polymer retention clip can include a irregular cross section and the wire within the clip can be bent into a desired shape by an orthodontic professional based upon the teeth of the patient, in accordance with the present disclosure;

FIG. 24 illustrates an exemplary retention clip including elongated gripping features corresponding to tooth and gum-line features of a patient in a gingival margin, in accordance with the present disclosure; and

FIG. 25 illustrates an exemplary retention clip including elongated gripping features corresponding to tooth and gum-line features of a patient in a gingival margin, wherein the clip spans between spaces formed between a first tooth and a second tooth and the second tooth and a third tooth, in accordance with the present disclosure.

### DETAILED DESCRIPTION

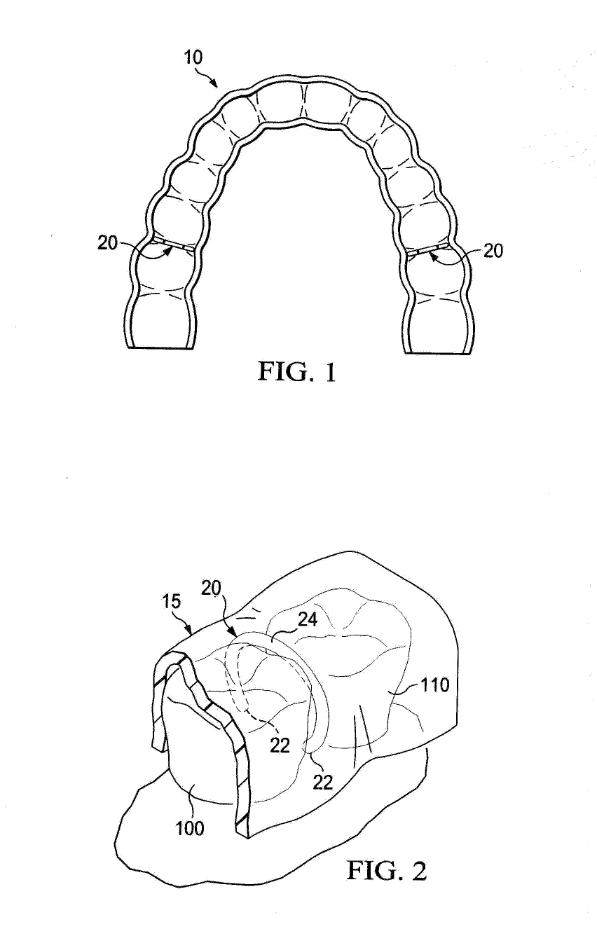

Referring now to the drawings, wherein the showings are for the purpose of illustrating certain exemplary embodiments only and not for the purpose of limiting the same, FIG. 1 illustrates an exemplary aligner tray including retention features. Aligner tray 10 is formed to the shape of one of a patient's top teeth or bottom teeth. Aligner tray 10 includes a series of tooth-shaped cavities configured to receive corresponding teeth of the patient. Aligner tray 10 includes at least one retention feature embodied as a retention clip 20 aligned to grasp the patient's teeth. A plurality of retention clips 20 can be used, aligned to a plurality of spaces between a patient's teeth. FIG. 1 illustrates an embodiment wherein two retention clips 20 are located symmetrically upon the aligner tray 10 or located at substantially identical locations on left and right sides of the aligner tray 10. In another embodiment, a different number of retention clips can be used in non-symmetrical locations upon the aligner tray. The retention clips 20 illustrated in FIG. 1 are each located between teeth toward the rear of the mouth. One having skill in the art would appreciate that the exemplary illustrated retention clips 20 are located between molars of the patient, however, retention clips can be used at various locations between different teeth and still be within the scope of the present disclosure. A location of a retention clip 20 can be equivalently described as being located between teeth of the patient and being located between tooth-shaped cavities on the aligner tray 10.

A retention feature can be made of a number of different materials, including a metal wire or a plastic or polymer material. A metal wire used as a retention feature can be made of a metal or an alloy including materials known in the art for use in a patient's mouth.

In one embodiment, retention clip 20 includes a C-shaped clip configured to fit between two of the tooth shaped cavities, such that when the aligner is placed upon the teeth of the patient, the C-shaped clip fits to the space between two of the patient's teeth, with the clip ends forming the open end of the C lightly contacting the two teeth forming the space near the bases of the teeth proximate to the patient's gums. The rest of the C-shaped is oriented to the space between the teeth, such that the closed end of the C extends above the crests of the teeth directly above the space between the teeth.

FIG. 2 illustrates an exemplary aligner tray including retention features located to the teeth of a patient. Section 15 of aligner tray 10 is illustrated including retention clip 20 placed upon patient's tooth 100 and tooth 110. Retention clip 20 includes two clip ends 22 which point inward and are configured to the geometry of the space between tooth 100 and tooth 110. Retention clip 20 is aligned to the space between tooth 100 and tooth 110, such that clip ends 22 lightly contact each of tooth 100 and tooth 110, providing a gripping force, retaining aligner tray 10 to the teeth of the patient. Closed end 24 of retention clip 20 extends above tooth 100 and tooth 110 and attaches to aligner tray 10.

A retention feature needs to be attached to aligner tray 10. In one embodiment, wherein aligner tray 10 is manufactured from a liquid plastic material, such as in an injection molding process, the retention feature can be set within the aligner tray as the tray is created. In another embodiment, wherein aligner tray 10 is manufactured from a solid blank, such as in a pressure-forming process, an adhering agent can be used to attach the retention feature to aligner tray 10. FIG. 3 illustrates an exemplary aligner tray, retention features, and an adhering agent locating the retention features to the aligner tray. Section 15 of aligner tray 10 is illustrated including retention clip 20 located between a first tooth-shaped cavity 40 and a second tooth shaped cavity 45. Retention clip 20 is connected to tray 10 with adhering agent 30. Adhering agent 30 can include any adhesive known in the art for use in a patient's mouth. According to one embodiment, adhering agent 30 can be a binary acrylic adhesive or a two-part adhesive composition. In another embodiment, adhering agent 30 can be a liquid cement known in the art. Retention clip 20 includes two clip ends 22 and closed end 24. Adhering agent 30 encapsulates closed end 24 and fixedly holds retention clip 20 in position relative to aligner tray 10. Adhering agent 30 is additionally connected to the inside surface of aligner tray 10. Closed end 24 must include sufficient clearance from the teeth of the patient to permit an adequate amount of adhering agent 30 to securely hold retention clip 20.

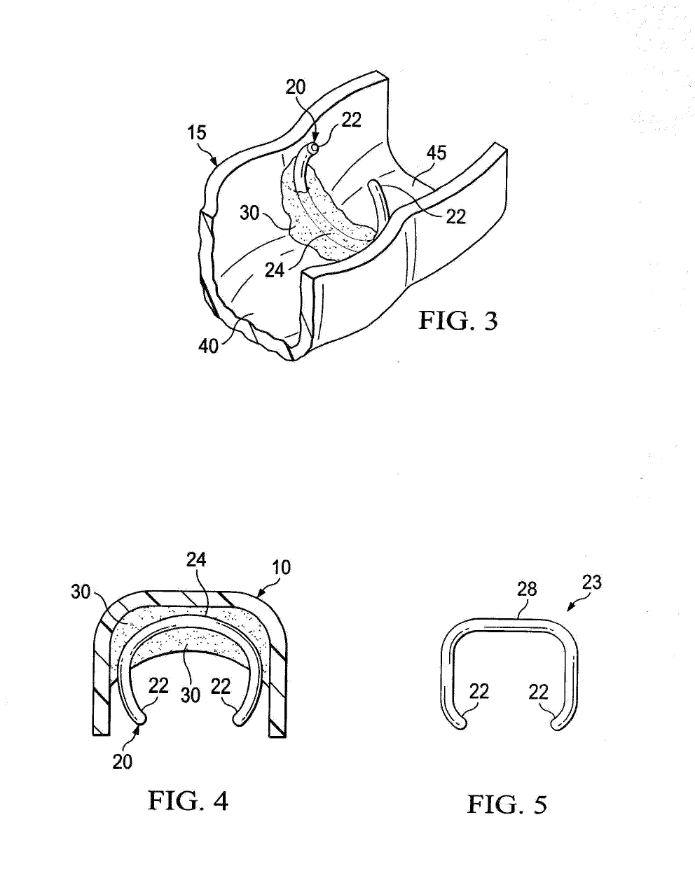

FIG. 4 illustrates in cross section an exemplary aligner tray, a C-shaped clip, and an adhering agent. Aligner tray 10 is illustrated including retention clip 20 and adhering agent 30. Retention clip 20 includes two clip ends 22 and closed end 24. Adhering agent 30 encapsulates closed end 24 and fixedly holds retention clip 20 in position relative to aligner tray 10.

Retention clip 20 can include a number of different shapes. Retention clip 20 can be a C-shaped clip as illustrated in FIG. 4. FIG. 5 illustrates an exemplary square retention clip. Retention clip 23 includes two clip ends 22 and a squared closed end 28. A number of shapes for retention clips are envisioned, and the disclosure is not intended to be limited to the particular exemplary embodiments provided herein.

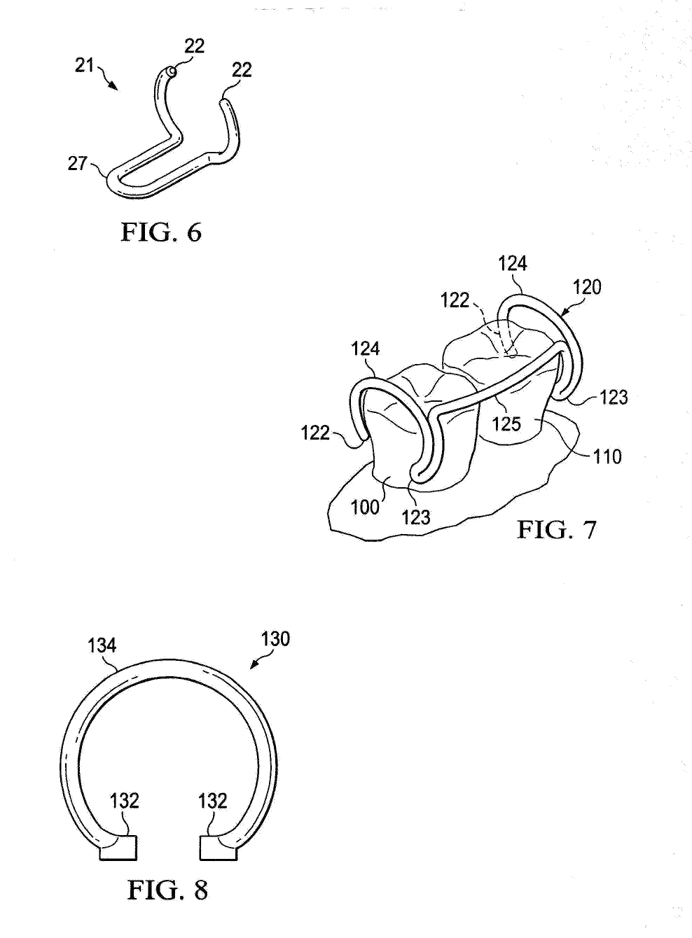

A retention clip can include a closed end which is encapsulated within an adhering agent. The closed end referred to in the disclosure includes the middle section of the exemplary C shape or the portion of the retention clip away from and connecting the clip ends. The closed end can include a complex shape to increase a length of the clip encapsulated within the adhering agent, thereby increasing the durability of the attachment of the retention clip to the aligner tray. FIG. 6 illustrates an exemplary retention clip with an extended closed end. Retention clip 21 includes two clip ends 22 and extended closed end 27. Clip ends 22 are oriented to be aligned to a space between two teeth of a patient. Extended closed end 27 projects in a perpendicular direction from the orientation of clip ends 22. Extended closed end 27 can be parallel to a flat section of aligner tray 10 and be partially or fully encapsulated by adhering agent 30. By encapsulating extended closed end 27, the attachment of retention clip 21 to aligner tray 10 can be achieved with increased durability. Further, extended closed end 27 can act as a spring member for retention clip 21, permitting clip ends 22 to flex, thereby gripping the teeth of the patient more effectively.

A retention feature can include a retention clip 20. In another exemplary embodiment, a retention feature can include a retention bracket aligned to a plurality of spaces between a patient's teeth. FIG. 7 illustrates an exemplary retention bracket aligned to a plurality spaces between teeth of a patient. Retention bracket 120 includes two clip ends 122, two bent clip ends 123, two closed ends 124, and a bracket arm 125. Retention bracket 120 is aligned to patient's tooth 100 and tooth 110. One of clip ends 122 and a corresponding one of bent clip ends 123 are aligned to a space between tooth 100 and an adjacent tooth next to tooth 100. A second of clip ends 122 and a corresponding second of bent clip ends 123 are aligned to a space between tooth 110 and a second adjacent tooth next to tooth 110. The two sets of clip ends 122 and bent clip ends 123 provide retention bracket 120 with retention details located to two spaces between teeth of the patient. Bracket arm 125 connects the two sides of retention bracket 120. One having skill in the art will appreciate that retention bracket 120 forms a rigid frame that can be configured to fit to and durably retain the shape of a plurality of spaces between teeth of a patient. Further, closed ends 124 and bracket arm 125 can all be encapsulated by an adhering agent 30 to provide an attachment to aligner tray 10 with increased durability. Retention bracket 120 can include a number of embodiments. FIG. 7 illustrates a retention bracket 120 including retention details between a tooth 100 and an adjacent tooth and details between a tooth 110 and another adjacent tooth. In another embodiment, retention bracket can include retention details between a first tooth and an adjacent second tooth, and additional details between the first tooth and another adjacent third tooth.

A retention bracket can be configured to attach to a number of teeth of the patient located in a series on one area of the patient's jaw. According to another embodiment, a retention bracket can span the mouth of the patient to locate to spaces between teeth of the patient on opposite sides of the jaw. In this way, a retention bracket can increase retention force to the teeth of the patient by gripping across the entire mouth of the patient. FIG. 11 illustrates an aligner tray including a retention bracket spanning both sides of the aligner tray. Configuration 300 includes aligner tray 310 including tooth-shaped cavities 312, 314, 316, and 318. Exemplary configuration 300 is configured to the upper jaw of a patient wherein top of the mouth does not include the structure of the tongue, and a central portion 324 of retention bracket 320 can curve upward in the mouth to stay along the top service of the mouth, but otherwise directly span the distance between the two sides of the mouth without having to avoid the patient's tongue. Retention bracket 320 is illustrated located on one side of aligner tray 310 to a space between tooth-shaped cavities 312 and 314, and retention bracket 320 is located on the other side of aligner tray 310 to a space between tooth-shaped cavities 316 and 318. Clip ends 322 are configured to grip to the teeth of the patient similarly to other clip ends disclosed herein. Central portion 324 of retention bracket 320 can include a spring member 330, adding flexibility to the bracket and providing improved retention force to the teeth of the patient.

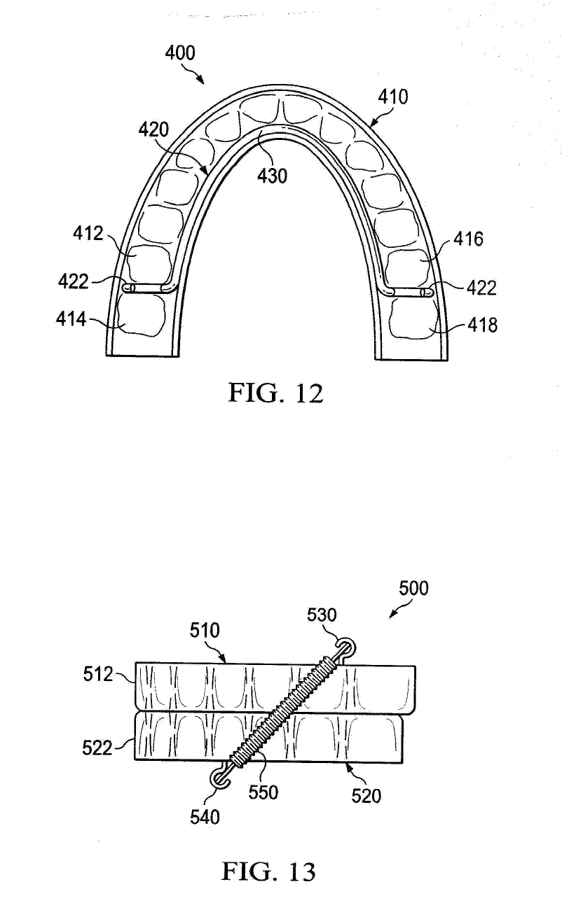

FIG. 12 illustrates an aligner tray including a retention bracket spanning both sides of the aligner tray including central portion of the bracket with a wide arc configuration. Configuration 400 includes aligner tray 410 including tooth-shaped cavities 412, 414, 416, and 418 and a retention bracket 420. Exemplary configuration 400 can be configured to either the upper jaw or lower jaw of a patient. A central portion 430 of retention bracket 420 can be configured to particular dental features of the mouth of the patient. The exemplary embodiment of central portion 430 includes a wide arc providing wide clearance of the central portion of the bracket from a center of the mouth of the patient, for example, merging the central portion 430 with an inner perimeter of aligner tray 410. A number of different embodiments for central portion 430 are envisioned according to different dental requirements. According to one embodiment, central portion 430 can be configured to avoid the tongue of the patient. In another embodiment, central portion 430 can be configured based upon orthodontic criteria known in the art. Retention bracket 420 is illustrated located on one side of aligner tray 410 to a space between tooth-shaped cavities 412 and 414, and retention bracket 420 is located on the other side of aligner tray 410 to a space between tooth-shaped cavities 416 and 418. Clip ends 422 are configured to grip to the teeth of the patient similarly to other clip ends disclosed herein. Central portion 430 of retention bracket 420 can provide a spring force to retention bracket 420, adding flexibility to the bracket and providing improved retention force to the teeth of the patient.

In one embodiment, a retention feature can be made of a metal wire. In another embodiment, a retention feature can be made of an alternative material, such as a polymer or a hard plastic material. FIG. 8 illustrates an exemplary retention clip made of a polymer. Retention clip 130 includes two clip ends 132 and a closed end 134. The polymer material for retention clip 130 can be selected from plastics and other similar materials known in the art for use in a patient's mouth. An exemplary retention clip 20 made from a single metal wire can include a single cross section of wire. Retention clip 130 can include any variety of cross sections, for example, adjusting an elasticity of different parts of retention clip 130, adding jagged or notched features to closed end 134 to increase gripping strength in the connection of retention feature 130 to adhering agent 30, or adjusting how clip ends 132 interact with the patient's teeth. A number of different cross sections can be selected for use in retention clip 130, and the disclosure is not intended to be limited to the particular exemplary embodiments provided herein.

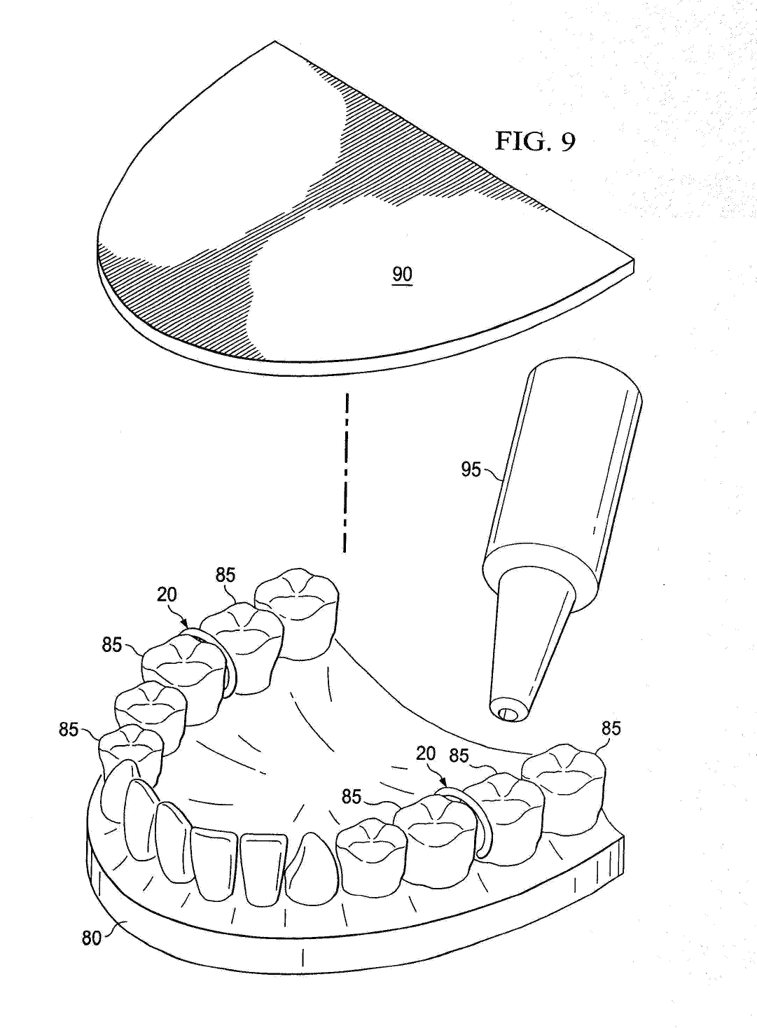

FIG. 9 illustrates exemplary retention features situated to or placed upon a dental impression including an adhering agent applied to the dental impression proximate to the retention features in preparation for a pressure-forming process. Dental impression 80 is a rigid physical model of a patient's teeth including a plurality of tooth features 85. Dental impression 80 is manufactured according to methods known in the art. In order to manufacture an aligner tray effective to adjust alignment and/or position of a patient's teeth, tooth features 85 can be adjusted based upon desired tooth adjustments. Dental impression 80 is located in a pressure-forming device known in the art which is configured to apply a pressure effective to form-fit a piece of polymer such as aligner tray blank 90 over a selected shape such as dental impression 80, such that a rigid plastic part is formed with cavities based upon features upon the selected shape. Using an aligner tray blank 90 to manufacture an aligner tray 10 using pressure-forming is known in the art. Retention clips 20 are each located to spaces between two tooth features 85. Retention clips 20 can be adjusted to a desired fit to the tooth features 85, adjusting size or width of the gap between the clip ends of the retention clips, according to methods known in the art. Adhering agent dispenser 95 is used to apply a measured amount of adhering agent to each of retention clip 20. An adhering agent can be selected that begins in a semi-liquid or paste form and sets to a solid over time. Additionally, an adhering agent can be selected that includes sufficient viscosity, such that being placed between dental impression 80 and aligner tray blank 90 during a pressure-forming process, the aligner tray blank 90 is formed around the adhering agent. Aligner tray blank 90 can be a thin, flat polymer sheet made of a material known in the art used in pressure-forming. In one embodiment, aligner tray blank 90 can be a clear polymer, such that the resulting aligner tray is a clear aligner tray. Aligner tray blank 90 is located to be placed over dental impression 80 and subsequently pressure formed to the dental impression 80 including the retention clips 20 and adhering agent. After the adhering agent sets, the resulting aligner tray 10 including connected retention clips 20 can be removed from the dental impression 80.

Orthodontic appliances are used for additional dental applications. For example, methods are known to use an elastic band or bands to remedy an alignment of the lower jaw of a patient to the upper jaw. Under certain circumstances, by applying a tensile force upon the lower jaw, an orthodontic appliance can encourage growth of the lower jaw in a forward direction, correcting a lower jaw that is too short for a proper alignment to the upper jaw. Similarly, compressive force on the lower jaw of a patient can discourage or slow growth in the lower jaw. Known methods to attach an elastic band to the teeth of the patient include bonding or permanently adhering an elastic band retention feature to a tooth upon the upper jaw and another elastic band retention feature to a tooth on the lower jaw.

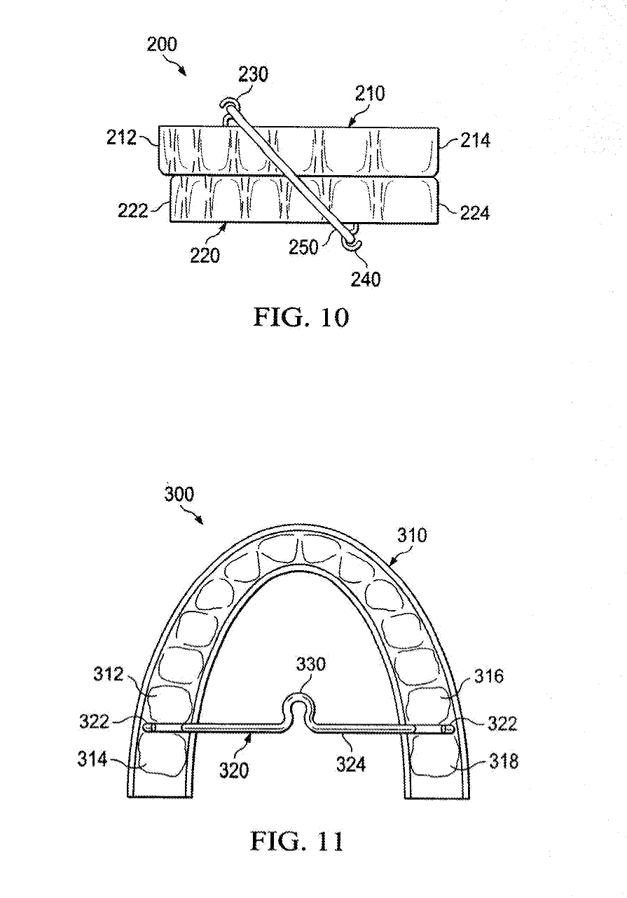

Known aligner tray configurations cannot utilize band retention features. The force applied by the elastic bands would act to dislodge one or both of the aligner trays from the teeth of the patient. However, with the retention features disclosed herein, sufficient retention force to the teeth of the patient can be achieved, such that elastic band retention features can be located to the aligner trays. FIG. 10 illustrates an aligner tray corresponding to an upper jaw of a patient, an aligner tray corresponding to a lower jaw of a patient, and elastic band retention features located to each of the aligner trays. Configuration 200 is illustrated including upper aligner tray 210, including a front 212 of the tray and a rear 214 of the tray. Lower aligner tray 220 is illustrated, including a front 222 of the tray and a rear 224 of the tray. Each of the upper tray 210 and the lower tray 220 include retention features according to one of the embodiments of the disclosure. According to one embodiment, a retention bracket such as is illustrated in FIG. 7 can be utilized to maximize a retention force to the teeth. Upper tray 210 includes an elastic band retention feature 230, and lower tray 220 includes an elastic band retention feature 240. Elastic band 250 is illustrated spanning the distance between elastic band retention features 230 and 240. Each of exemplary elastic band retention features 230 and 240 include small curved hooks with open ends pointing away from the elastic band 250. Each of elastic band retention feature 230 and elastic band retention feature 240 can be an extension of a retention feature adhered to the aligner tray. For example, retention clip 21 of FIG. 6 can include one of the clip ends 22 modified and extended to form an elastic band retention feature. Similarly, the retention bracket 120 of FIG. 7 can include one of the clip ends 22 modified and extended to form an elastic band retention feature. Each aligner tray can include an elastic band retention feature on each side of the aligner tray, such that an elastic band can be attached to the elastic band retention features on each the left and right side of the mouth of the patient. A number of retention features with an elastic band retention feature located thereto are envisioned, and the disclosure is not intended to be limited to the particular exemplary embodiments provided herein. FIG. 10 illustrates elastic band retention features and elastic bands configured to pull forward on the jaw. Depending upon the desired orthodontic effect, the configuration can be reversed to pull backward on the lower jaw. Further, a required location for a retention feature upon the aligner tray, for example, based upon the particulars of a patient's teeth, can be different from the location required for the elastic band retention feature to create the desired force upon the jaws of the patient. In such a circumstance, an elastic band retention feature can be adhered to the aligner tray according to methods disclosed herein at a separate location from the retention features located to the tray.

FIG. 10 illustrates elastic bands applying a force upon the lower jaw by pulling upon the jaw. FIG. 13 illustrates a piston device pushing upon the lower jaw in a forward direction. Configuration 500 is illustrated including upper aligner tray 510, including a front 512 of the tray and a rear 514 of the tray. Lower aligner tray 520 is illustrated, including a front 522 of the tray and a rear 524 of the tray. Each of the upper tray 510 and the lower tray 520 include retention features according to one of the embodiments of the disclosure. According to one embodiment, a retention bracket such as is illustrated in FIG. 7 can be utilized to maximize a retention force to the teeth. Upper tray 510 includes a piston retention feature 330, and lower tray 520 includes a piston retention feature 540. Piston device 550 is illustrated spanning the distance between piston retention features 530 and 540. Each of exemplary piston retention features 530 and 540 include small curved hooks with open ends pointing toward the piston 550. Each of piston retention feature 530 and piston retention feature 540 can be an extension of a retention feature adhered to the aligner tray. A plurality of piston devices can be used at different locations, such as opposite sides of the mouth, and the configuration can be reversed such that the piston creates a force upon the lower jaw in a rearward direction.

A retention feature or retention clip can be adhered or otherwise affixed to an aligner tray. A clip with a smooth shape can be adhered or affixed according to methods known in the art. However, it will be appreciated that glues and other adhering agents stick to objects with complex shapes and with large surface areas better than such agents stick to small objects with little surface areas. An aligner tray can be frequently taken out and put back into a patient's mouth. As a result, improved adhesion of the retention clip to the aligner tray can be beneficial and improve the useful life of the aligner tray. Configurations and methods are disclosed to improve adhesion of a retention feature or clip to an aligner tray by adding affixing features to the retention feature or clip.

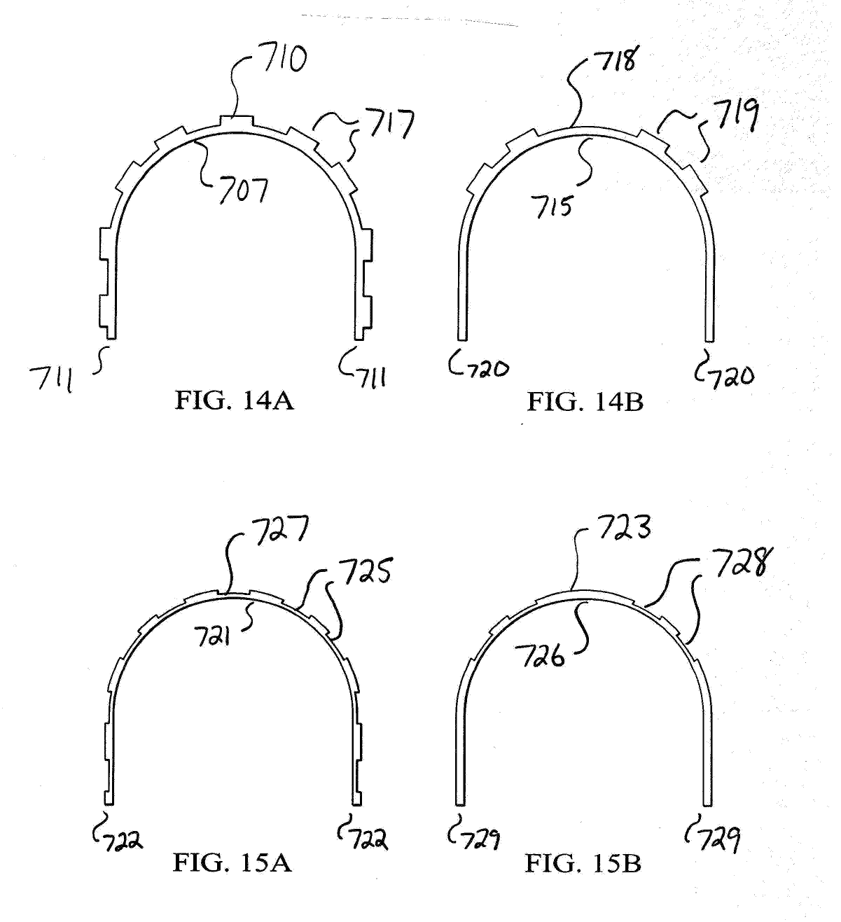

FIG. 14A illustrates an exemplary rounded or arcuate retention clip that can be embedded in, adhered to, or otherwise affixed to an exemplary aligner tray. Retention clip 707 includes two clip ends 711 and a rounded closed end 710. Rounded closed end 710 can also be described as a middle section of the clip that connects the two clip ends. Clip ends 711 are configured to grip to the teeth of the patient similarly to other clip ends disclosed herein. Referring to the exemplary aligner tray of FIG. 4, closed end 710 of FIG. 14A has affixing features 717 embodied as raised protrusions that increase the surface area and increases the mechanical bond to exemplary aligner tray 10 of FIG. 4 and is partially or fully encapsulated by the material of aligner tray 10. Affixing features 717 are located along an outside perimeter of clip 707 such that the raised protrusions are pointed outward away from the teeth of the patient and into the material of the aligner tray. By configuring closed end 710 with the raised protrusions, the attachment of retention clip 707 to aligner tray 10 can be achieved with increased durability.

In an exemplary method to manufacture an aligner tray with clip 707, an aligner tray blank is positioned over a dental impression and subsequently heat and pressure formed to the dental impression including the retention clips 707, such that the tray material forms fully or partially around retention clips 707, with or without an adhering agent. The tray, once hardened into a permanent state and formed into shape around clips 707, holds the clips securely in place.

A number of embodiments of raised protrusions are envisioned. In one embodiment illustrated in FIG. 14B, a retention clip 715 includes a pair of affixing features 719 embodied as raised protrusions positioned on each side of the clip proximate to closed end 718 of clip 715. Clip 715 further includes clip ends 720 to grip to the teeth of the patient similarly to other clip ends disclosed herein. The illustrated raised protrusions include orthogonal raised bumps, however, any shape of raised protrusion can be utilized. A number of quantities, placements, and configurations of raised protrusions and shapes for retention clips are envisioned, and the disclosure is not intended to be limited to the particular exemplary embodiments provided herein.

FIG. 15A illustrates an exemplary rounded or arcuate retention clip that can be embedded in, adhered to, or otherwise affixed to an exemplary aligner tray. Retention clip 721 includes two clip ends 722 and a rounded closed end 727. Rounded closed end 727 can also be described as a middle section of the clip that connects the two clip ends. Clip ends 722 are configured to grip to the teeth of the patient similarly to other clip ends disclosed herein. Referring to the exemplary aligner tray of FIG. 4, closed end 727 of FIG. 15A has affixing features 725 embodied as depressed indentations that increase the surface area and increases the mechanical bond to exemplary aligner tray 10 of FIG. 4 and is partially or fully encapsulated by the material of aligner tray 10. Affixing features 725 are located along an outside perimeter of clip 721 such that the depressed indentations are pointed outward away from the teeth of the patient and into the material of the aligner tray. By configuring closed end 727 with the depressed indentations, the attachment of retention clip 721 to aligner tray 10 can be achieved with increased durability.

In an exemplary method to manufacture an aligner tray with clip 721, an aligner tray blank is positioned over a dental impression and subsequently heat and pressure formed to the dental impression including the retention clips 721, such that the tray material forms fully or partially around retention clips 721, with or without an adhering agent. The tray, once hardened into a permanent state and formed into shape around clips 721, holds the clips securely in place.

A number of embodiments of depressed indentations are envisioned. In one embodiment illustrated in FIG. 15B, a retention clip 726 includes a pair of affixing features 728 embodied as depressed indentations positioned on each side of the clip proximate to closed end 723 of clip 726. Clip 726 further includes clip ends 729 to grip to the teeth of the patient similarly to other clip ends disclosed herein. The illustrated depressed indentations include orthogonal depressions, however, any shape of depressions can be utilized. A number of quantities, placements, and configurations of depressed indentations and shapes for retention clips are envisioned, and the disclosure is not intended to be limited to the particular exemplary embodiments provided herein.

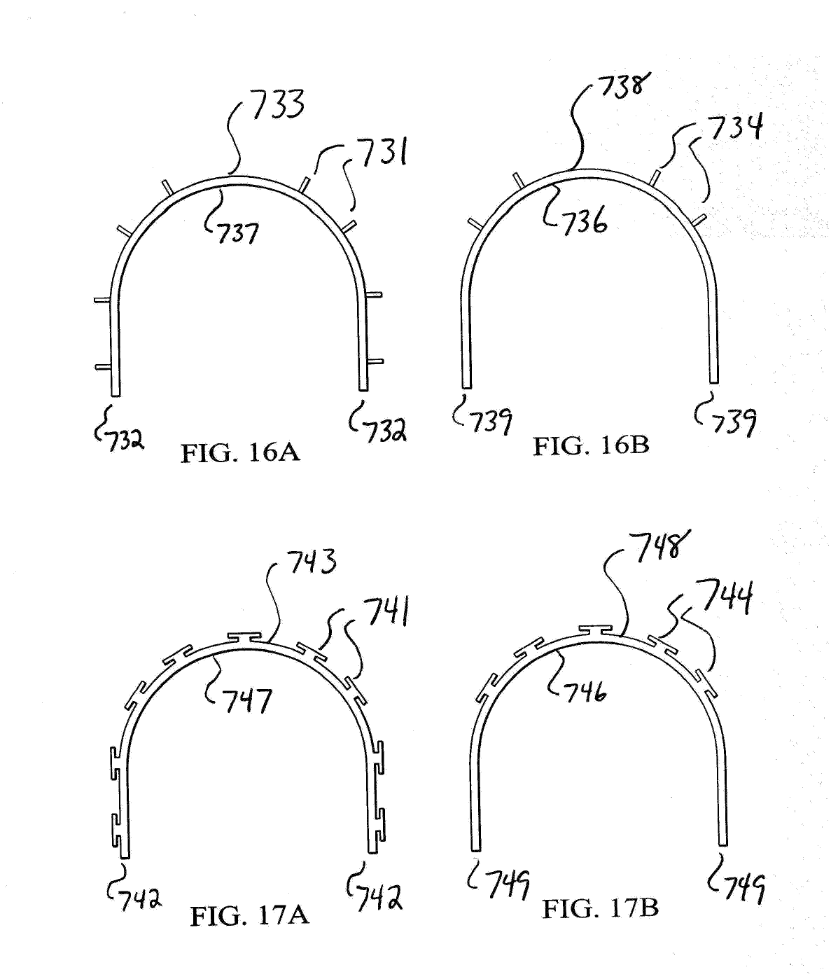

FIG. 16A illustrates an exemplary rounded or arcuate retention clip that can be embedded in, adhered to, or otherwise affixed to an exemplary aligner tray. Retention clip 737 includes two clip ends 732 and a rounded closed end 733. Rounded closed end 733 can also be described as a middle section of the clip that connects the two clip ends. Clip ends 732 are configured to grip to the teeth of the patient similarly to other clip ends disclosed herein. Referring to the exemplary aligner tray of FIG. 4, closed end 733 of FIG. 16A has affixing features 731 embodied as projecting tabs that increase the surface area and increases the mechanical bond to exemplary aligner tray 10 of FIG. 4 and is partially or fully encapsulated by the material of aligner tray 10. Affixing features 731 are located along an outside perimeter of clip 737 such that the raised protrusions are pointed outward away from the teeth of the patient and into the material of the aligner tray. By configuring closed end 733 with the projecting tabs, the attachment of retention clip 737 to aligner tray 10 can be achieved with increased durability.

In an exemplary method to manufacture an aligner tray with clip 737, an aligner tray blank is positioned over a dental impression and subsequently heat and pressure formed to the dental impression including the retention clips 737, such that the tray material forms fully or partially around retention clips 737, with or without an adhering agent. The tray, once hardened into a permanent state and formed into shape around clips 737, holds the clips securely in place.

A number of embodiments of projecting tabs are envisioned. In one embodiment illustrated in FIG. 16B, a retention clip 736 includes a pair of affixing features 734 embodied as projecting tabs positioned on each side of the clip proximate to closed end 738 of clip 736. Clip 736 further includes clip ends 739 to grip to the teeth of the patient similarly to other clip ends disclosed herein. The illustrated projecting tabs include orthogonal projections, however, and shape of tab can be utilized. A number of quantities, placements, and configurations of tabs and shapes for retention clips are envisioned, and the disclosure is not intended to be limited to the particular exemplary embodiments provided herein.

FIG. 17A illustrates an exemplary rounded or arcuate retention clip that can be embedded in, adhered to, or otherwise affixed to an exemplary aligner tray. Retention clip 747 includes two clip ends 742 and a rounded closed end 743. Rounded closed end 743 can also be described as a middle section of the clip that connects the two clip ends. Clip ends 742 are configured to grip to the teeth of the patient similarly to other clip ends disclosed herein. Referring to the exemplary aligner tray of FIG. 4, closed end 743 of FIG. 17A has affixing features 741 embodied as mushroom-shaped tabs that increase the surface area and increases the mechanical bond to exemplary aligner tray 10 of FIG. 4 and is partially or fully encapsulated by the material of aligner tray 10. Affixing features 741 are located along an outside perimeter of clip 747 such that the raised protrusions are pointed outward away from the teeth of the patient and into the material of the aligner tray. By configuring closed end 743 with the mushroom-shaped tabs, the attachment of retention clip 747 to aligner tray 10 can be achieved with increased durability.

In an exemplary method to manufacture an aligner tray with clip 747, an aligner tray blank is positioned over a dental impression and subsequently heat and pressure formed to the dental impression including the retention clips 747, such that the tray material forms fully or partially around retention clips 747, with or without an adhering agent. The tray, once hardened into a permanent state and formed into shape around clips 747, holds the clips securely in place.

A number of embodiments of mushroom-shaped tabs are envisioned. In one embodiment illustrated in FIG. 17B, a retention clip 746 includes a pair of affixing features 744 embodied as mushroom-shaped tabs positioned on each side of the clip proximate to closed end 748 of clip 746. Clip 746 further includes clip ends 749 to grip to the teeth of the patient similarly to other clip ends disclosed herein. The illustrated mushroom-shaped tabs include orthogonal projections, however, and shape of tab can be utilized. A number of quantities, placements, and configurations of tabs and shapes for retention clips are envisioned, and the disclosure is not intended to be limited to the particular exemplary embodiments provided herein.

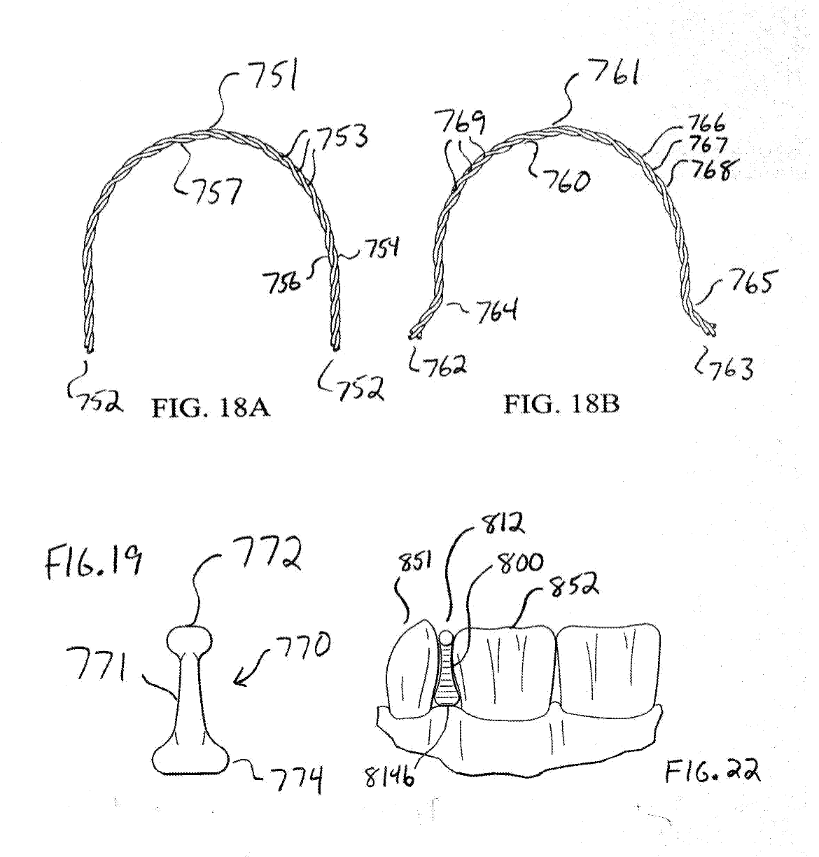

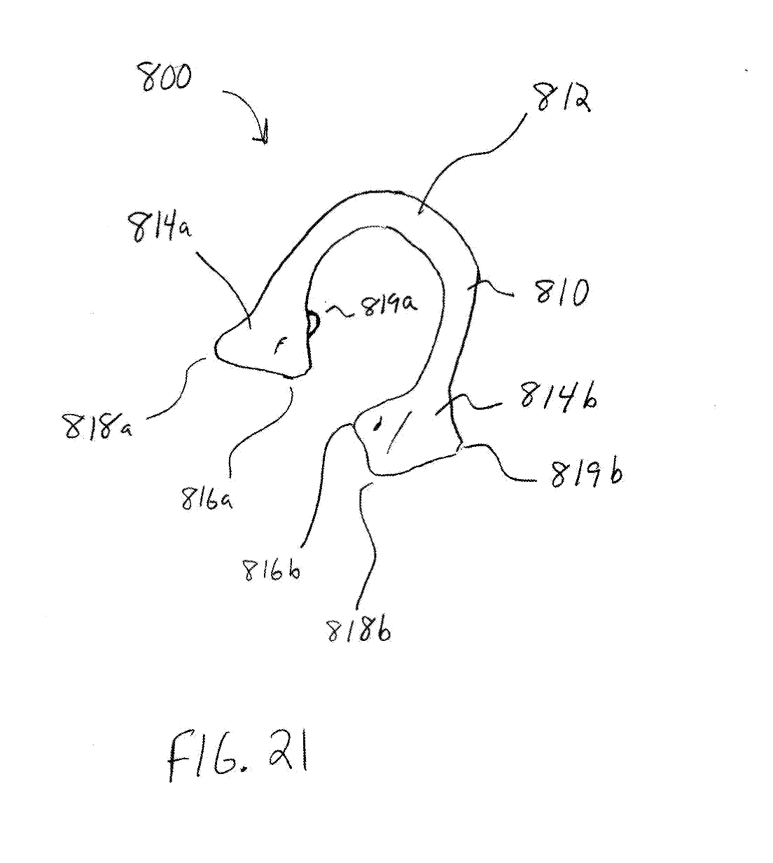

FIG. 18A illustrates an exemplary rounded or arcuate retention clip that can be embedded in, adhered to, or otherwise affixed to an exemplary aligner tray. Retention clip 757 includes two clip ends 752 and a rounded closed end 751. Rounded closed end 751 can also be described as a middle section of the clip that connects the two clip ends. Clip ends 752 are configured to grip to the teeth of the patient similarly to other clip ends disclosed herein. Clip 757 is configured as at least two small wires wrapped around each other. Clip 757 could similarly be constructed of a plurality of wires 754 and 756 wrapped or braided based upon any configuration known in the art. Clip 757 includes affixing features 753 embodied as creases formed between wires 754 and 756. By configuring clip 757 with the creases formed between the wrapped wires, the material of an aligner tray or the adhering agent applied to the clip and the aligner tray can form within the creases, thereby increasing surface area and a locking grip between the clip and the aligner tray. In this way, the attachment of retention clip 757 to an aligner tray can be achieved with increased durability.

In an exemplary method to manufacture an aligner tray with clip 757, an aligner tray blank is positioned over a dental impression and subsequently heat and pressure formed to the dental impression including the retention clips 757, such that the tray material forms fully or partially around retention clips 757, with or without an adhering agent. The tray, once hardened into a permanent state and formed into shape around clips 757, holds the clips securely in place.

A number of embodiments of wrapped or braided wires are envisioned. In one embodiment illustrated in FIG. 18B, a retention clip 760 includes affixing features 769 embodied as creases formed between wrapped wires 766, 767, and 768. Clip 760 further includes a closed end 761 and clip ends 762 and 763 to grip to the teeth of the patient similarly to other clip ends disclosed herein. The illustrated clip ends 762 and 763 are each illustrated bent out at bends 764 and 765, respectively, away from the gums of the patient, thereby permitting clip 760 to grip the teeth of the patient while preventing ends 762 and 763 from irritating the gums of the patient.

FIG. 19 illustrates in side view an exemplary retention clip that can be used to grip to the teeth of a patient, wherein the clip includes an irregular cross section. Retention clip 770 includes two clip ends 774 and a rounded closed end 772. Clip ends 774 are configured to grip to the teeth of the patient similarly to other clip ends disclosed herein, yet the curvature of the clip hooks in-between two adjacent teeth, widening near the gingival margin and narrowing near the top tooth surfaces. Clip 770 including an irregular cross section can in some embodiments be advantageously constructed of a polymer material. The irregular cross section of clip 770 can be used to increase an area of contact between the clip and the teeth near the gingival margin. Further the irregular cross section of clip 770 can be used to increase a surface area of closed end 772 to increase a strength of a bond between clip 770 and an adjacent aligner tray. Closed end 772 can have a smooth surface or any of the surfaces described, including mushroom shaped protrusions; groves and spiraled ridges; or raised or recessed protrusions to improve the strength of the bond to the aligner tray. A number of configurations of retention clips with irregular cross sections are envisioned, and the disclosure is not intended to be limited to the particular exemplary embodiments provided herein.

FIG. 20 illustrates another exemplary embodiment of a retention clip with an irregular cross section. Clip 900 is illustrated including clip ends 914a and 914b and a closed end 912. Closed end 912 or the portion of the clip connecting the two clip ends is widened to promote a strong bond between the clip and an adjacent aligner tray. Closed end 912 further includes mushroom-shaped affixing features 920a and 920b for the purpose of increasing surface area between the clip and the aligner tray or the adhering agent between the clip and the tray. Clip 900 includes narrow sides 910, promoting flexing of the sides when the clip ends come into contact with the teeth of the patient.

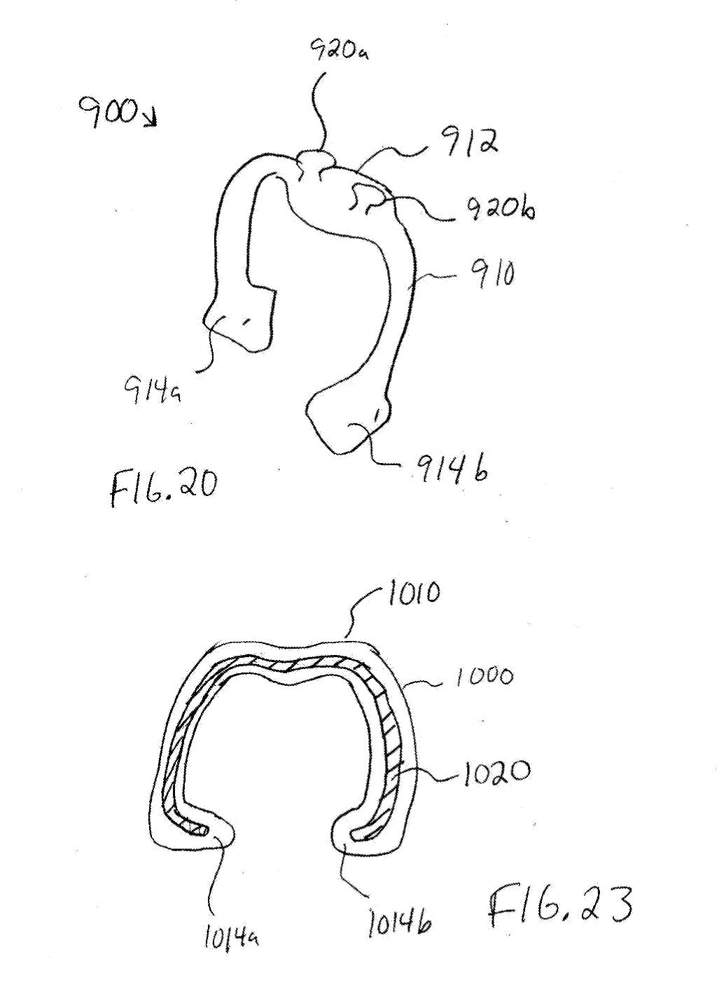

FIG. 21 illustrates another exemplary embodiment of a retention clip with an irregular cross section. Clip 800 is illustrated including clip ends 818a and 818b and a closed end 812. Closed end 812 describes the portion of the clip connecting the two clip ends. Clip end 814a includes tip 816a which is installed to be situated close to a gap between a first tooth and a second tooth, tip 818a which is installed to be situated along the first tooth, and tip 819a which is installed to be situated along the second tooth. Similarly, clip end 814b includes tip 816b which is installed to be situated close to a gap between a first tooth and a second tooth, tip 818b which is installed to be situated along the first tooth, and tip 819b which is installed to be situated along the second tooth. Clip 800 includes narrow sides 810, promoting flexing of the sides when the clip ends come into contact with the teeth of the patient.

FIG. 22 illustrates the retention clip of FIG. 21 installed to the teeth of a patient. Clip 800 is installed between first tooth 851 and second tooth 852. Clip end 812, when adhered to an aligner tray, holds the aligner tray in a desired orientation to the patient's teeth. Clip end 814b is illustrated, aligned to the teeth near the gingival margin.

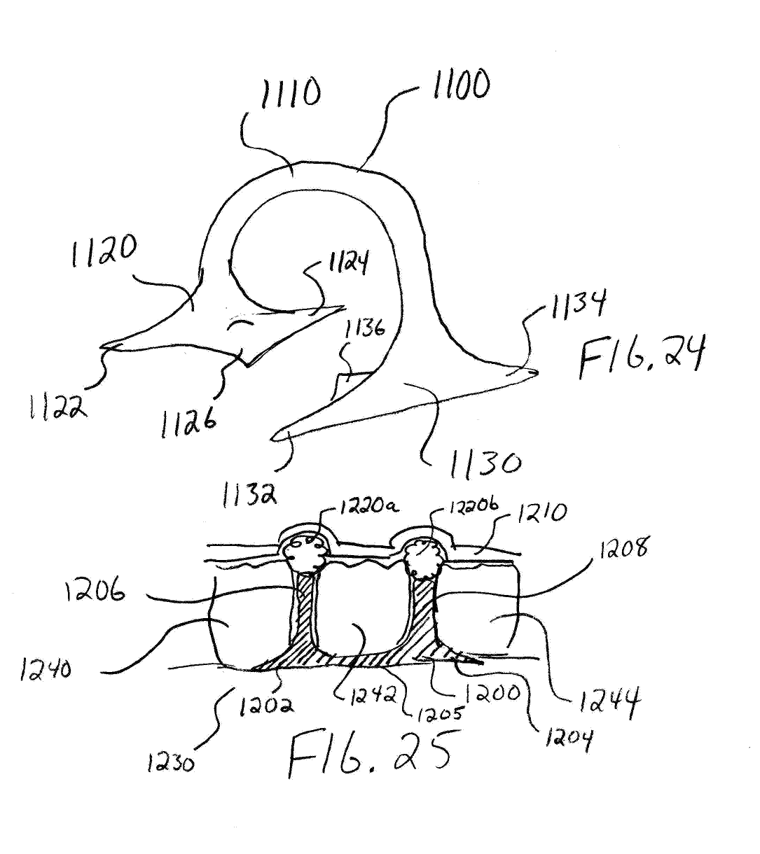

FIG. 23 illustrates a polymer retention clip formed around a wire, wherein the polymer retention clip can include a irregular cross section and the wire within the clip can be bent into a desired shape by an orthodontic professional based upon the teeth of the patient. Retention clip 100 includes polymer material 1010 and orthodontic wire 1020. Polymer material 1010 can be fitted to a desired shape, for example, increasing a contact area with the gingival margin between two teeth at clip ends 1014a and 1014b and widening at a closed end of the clip to maximize a bond strength between the clip and an adjacent aligner tray. Wire 1020 can be bent by the professional using a fine instrument to make adjustments to how the clip interacts with the teeth of the patient, the wire retaining the desired shape through repeated use.

FIG. 24 illustrates an exemplary retention clip including elongated gripping features corresponding to tooth and gum-line features of a patient in a gingival margin. Clip 1100 includes closed end 1110 and two clip ends 1120 and 1130, Clip end 1120 includes enlongated features 1122 and 1124 that extend along the patient's teeth and removeably grip thereto. Because the features are elongated, a surface area of contact between the clip and the teeth in the area of the gum-line is increased. Clip end 1120 further includes feature 1126 to align the clip to a space between the two adjacent teeth. Clip end 1130 similarly includes elongated features 1132 and 1134 and a feature 1136. Clip 1100 can optionally include affixing features located to closed end 1110.

FIG. 25 illustrates an exemplary retention clip including elongated gripping features corresponding to tooth and gum-line features of a patient in a gingival margin, wherein the clip spans between spaces formed between a first tooth and a second tooth and the second tooth and a third tooth. Retention clip 1200 includes a pair of C-shaped clip features 1206 and 1208, wherein each C-shaped clip feature is aligned respectively to a first space between tooth 1240 and tooth 1242 and a second space between tooth 1242 and third tooth 1244. The two C-shaped clip features 1206 and 1208 are essentially similar to clip 1100 of FIG. 24, except that the clips are joined at point 1205, such that elongated features of feature 1206 is joined with elongated features of feature 1208. In this way, retention clip 1200 has a contacting surface area to the teeth from elongated feature 1202 to elongated feature 1204. Clip 1200 is illustrated adhered to aligner tray 1210 with adhering agents 1220a and 1220b. According to one embodiment, an orthodontic professional can have access to a plurality of retention clips 1200 with different dimensions, for example, with different distances between features 1206 and 1208, such that a properly sized clip can be selected for a particular patient.

According to one embodiment, a retention clip for use in removeably securing an aligner tray to teeth of a patient is disclosed, wherein the retention clip is a contiguous structure that spans from a gingival margin between two teeth, proximate to the location where the two teeth meet the gum-line on the inside of the teeth or the tongue-side or lingual-side of the teeth, to the gingival margin between the same two teeth, proximate to the location where the same two teeth meet the gum-line on the outside of the teeth or the cheek-side or labial side of the teeth. According to one embodiment, this retention clip is substantially located in a planar surface defined by the space between two teeth or the region between a distal surface of a first tooth and a mesial surface of a second adjacent tooth. Such an exemplary clip can be described herein as a single contiguous retention feature or clip aligned to the space between two adjacent teeth and spanning from a lingual gingival margin to a labial gingival margin. Wherein the exemplary clip is a C-shaped retention clip, the clip can be described as a C-shaped clip aligned to the space between two adjacent teeth, with one clip end proximate to a lingual gingival margin, with a second clip end proximate to a labial gingival margin, and with a closed end of the C-shaped clip proximate to the space between the two coronal surfaces of the two teeth.

Throughout the disclosure, C-shaped retention clips are described as having clip ends and a closed end. It will be understood throughout that a closed end of a clip includes a portion of the clip that is distant from and connects the two clip ends and is distinct from an open end of the clip formed by the two clip ends.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Apparatus to retain an orthodontic aligner tray to teeth of a patient, the apparatus comprising:
the aligner tray comprising a plurality of tooth-shaped cavities, the aligner tray comprising a plastic tray formed from a plastic plate of uniform thickness;
a retention feature comprising a C-shaped clip securing the aligner tray to the teeth of the patient, wherein C-shaped clip comprises:
a single contiguous retention feature aligned to a space between two adjacent teeth and spanning from a first terminal end of the C-shaped clip at a lingual gingival margin to a second terminal end of the C-shaped clip at a labial gingival margin; and
at least one elongated feature in one of the lingual gingival margin and the labial gingival margin extending perpendicularly from a body of the C-shaped clip along a gum line to increase gripping force upon the teeth; and
an adhering agent connecting the aligner tray and the retention feature.

2. The apparatus of claim 1, wherein the C-shaped clip further comprises two elongated features at each terminal end of the C-shaped clip, each elongated feature extending perpendicularly from the body of the C-shaped clip along the gum line to increase gripping force upon the teeth.

3. The apparatus of claim 1, wherein the C-shaped clip further comprises a mushroom-shaped affixing feature attached to the body of the C-shaped clip to increase adhesion between the C-shaped clip and the aligner tray.
